(19) United States
(12) Patent Application Publication
(10) Pub. No.: US 2018/0264780 A1
(43) Pub. Date: Sep. 20, 2018

(54) POROUS PAPER SHEET, AND DEVICE AND METHOD OF MANUFACTURING SAME

(71) Applicant: Cheol-Soo KIM, Busan (KR)

(72) Inventor: Cheol-Soo KIM, Busan (KR)

(21) Appl. No.: 15/760,003

(22) PCT Filed: Aug. 23, 2016
(86) PCT No.: PCT/KR2016/009326

§ 371 Date: Mar. 14, 2018

(30) Foreign Application Priority Data
Sep. 14, 2015 (KR) 10-2015-0130142
Aug. 18, 2016 (KR) 10-2016-0104856

(51) Int. Cl. B32B 7/12; B65D 65/40; B65D 65/42; B65D 65/46; B27N 3/08; B31F 5/04

(52) U.S. Cl. CPC B32B 7/12; B65D 65/40; B31F 5/04; B65D 65/46; B27N 3/08; B65D 65/42

(57) ABSTRACT

A porous paper sheet includes a first base material; and paper pieces laminated on the first base material, and adhered to each other or adhered to the first base material using an adhesive such that the paper pieces have predetermined pores therebetween. The paper pieces are shredded in a predetermined size. A device for manufacturing the porous paper sheet, includes: a first base material feeder feeding a first base material; a conveyor unit including a conveyor belt on which the first base material is placed and rollers driving the conveyor belt; an adhesive nozzle positioned above the conveyor belt and applying an adhesive to the first base material; and a paper piece feeder positioned above the conveyor belt and feeding paper pieces to the first base material.

### TECHNICAL FIELD

The present invention relates generally to a porous paper sheet, and device and method of manufacturing the same. More particularly, the present invention relates to a porous paper sheet, and device and method of manufacturing the same, in which the porous paper sheet is formed by applying an adhesive to shredded paper and compressing the same.

### BACKGROUND ART

In the present invention, the term “porous paper sheet” means a product that is manufactured by shredding paper into fine pieces having a predetermined size and then the shredded paper pieces are adhered to each other using an adhesive such that a large number of pores are present therein. Since such a porous paper sheet has cushioning properties, it can be used as a packaging material. For example, the porous paper sheet is used as a cushioning material placed inside a box when packaging an electronic product, etc. or as a packaging material used to cushion and wrap a fragile product such as an egg.

In the related art, as seen in the following related art documents, there is a case where a packaging material is manufactured by using paper made from waste paper, more precisely by using paper pulp. In other words, after foreign matter present in the waste paper is removed, the waste paper is shredded and immersed in water, and then dehydrated such that the water amount is adjusted to reach equal to or less than a certain water amount. The dehydrated paper pulp with a reduced water amount is mixed with an adhesive, put into a molding machine to obtain a predetermined shape, dried, and then subjected to a post-treatment process.

In a case of manufacturing the packaging material by using the waste paper in such a manner, the fundamental challenge is to dry the paper pulp molded in a predetermined shape to remove remaining water after dehydration. This may require a large amount of energy during a drying process, leading to an increase in manufacturing cost of the packaging material.

Furthermore, in a case where water is used to manufacture paper pulp, a large amount of water may be required at the work site, and a separate contamination prevention device may be required for sewage treatment of water generated during dehydration.

### DISCLOSURE

### Technical Problem

Accordingly, the present invention has been made keeping in mind the above problems occurring in the related art, and an object of the present invention is to provide a novel porous paper sheet, in which energy consumed during a manufacturing process is minimized.

Another object of the present invention is to provide a porous paper sheet, in which no water is used during manufacturing thereof.

A further object of the present invention is to provide a device and a method of manufacturing a porous paper sheet, in which manufacturing of the porous paper sheet is efficiently performed and a good yield is achieved.

### Technical Solution

In order to accomplish the above object, the present invention provides a porous paper sheet, including: a first base material; and paper pieces laminated on the first base material, and adhered to each other or adhered to the first base material using an adhesive such that the paper pieces have predetermined pores therebetween, the paper pieces being shredded in a predetermined size.

The porous paper sheet may further include: a second base material provided at a position opposite to the first base material and adhered to the laminated paper pieces using the adhesive so as to cover the paper pieces.

A pre-compression configuration may be provided such that the first base material or the second base material includes a first layer having first tear lines formed in a lattice shape and a second layer having second tear lines formed in a lattice shape at a position apart from the first fold lines of the first layer.

The pre-compression configuration may be provided such that vertices of the lattice shape formed by the second tear lines are located at geometric centers of the lattice shape formed by the first tear lines.

According to another aspect of the present invention, there is provided a device for manufacturing a porous paper sheet, the device including: a first base material feeder feeding a first base material; a conveyor unit including a conveyor belt on which the first base material is placed and rollers driving the conveyor belt; an adhesive nozzle positioned above the conveyor belt and applying an adhesive to the first base material; and a paper piece feeder positioned above the conveyor belt and feeding paper pieces to the first base material.

A plurality of adhesive nozzles and a plurality of paper piece feeders may be arranged in an alternate manner.

The device may further include: a drying unit drying the porous paper sheet having passed through the conveyor belt.

The paper piece feeder may include: a feeding hopper provided with an interior space in which the paper pieces shredded are placed, and at a lower portion thereof with an outlet through which the paper pieces are discharged onto the conveyor belt; guide plates guiding the paper pieces to inclined surfaces formed at a lower portion of the interior space of the feeding hopper; and guide rollers respectively positioned between the inclined surfaces and the guide plates and guiding the paper pieces to the outlet at a constant speed.

The device may further include: a press provided with a lower mold and an upper mold to form the porous paper sheet having passed through the conveyor belt in a predetermined shape.

According to a further aspect of the present invention, there is provided a method of manufacturing a porous paper sheet configured such that paper pieces shredded to a predetermined size are adhered to each other using an adhesive on a first base material or adhered to the first base material such that the paper pieces have predetermined pores therebetween, the method including: feeding the first base material; applying the adhesive and the paper pieces alternately on the first base material; compressing the paper pieces having the pores therebetween and laminated on the first base material using the adhesive, and forming the paper pieces in a predetermined shape; and drying the first base material and the paper pieces to remove water contained therein.

The applying the adhesive and the paper pieces may be carried out a plurality of times.

### Advantageous Effects

The porous paper sheet according to the present invention, and the device and the method of manufacturing the same have the following effects.

In the present invention, in the manufacture of the porous paper sheet, paper to be a raw material is shredded into the pieces, and then the adhesive is applied thereto such that the paper pieces adhere to each other, whereby there is no need to use water. Furthermore, supply of heat for removing water is minimized and thus energy consumption is also minimized.

In addition, in the present invention, paper is only shredded and no water for pulping the shredded paper is used. Thus, the environment of the work site is improved and treatment of contaminated water is not required.

Moreover, in the present invention, in order to form a desired thickness of the porous paper sheet, the shredded paper applied with the adhesive is provided a plurality of times. Thus, a bonding state of the porous paper sheet in the thickness direction is firmly maintained, thus minimizing occurrence of defects.

### DESCRIPTION OF DRAWINGS

FIG. 1 is a sectional view showing a configuration of a preferred embodiment of a porous paper sheet according to the present invention.

FIG. 2 is a schematic view showing a preferred embodiment of a device for manufacturing a porous paper sheet according to the present invention.

FIG. 3 is a schematic cross-sectional view showing an interior structure of a paper piece feeder constituting the device according to the embodiment of the present invention.

FIG. 4 is a schematic side view showing a configuration of a press constituting the device according to the embodiment of the present invention.

FIG. 5 is a plan view showing that a first base material used in the present invention is composed of a first layer and a second layer.

FIG. 6 is a plan view showing a configuration of the first layer shown in FIG. 5.

FIG. 7 is a plan view showing a configuration of the second layer shown in FIG. 5.

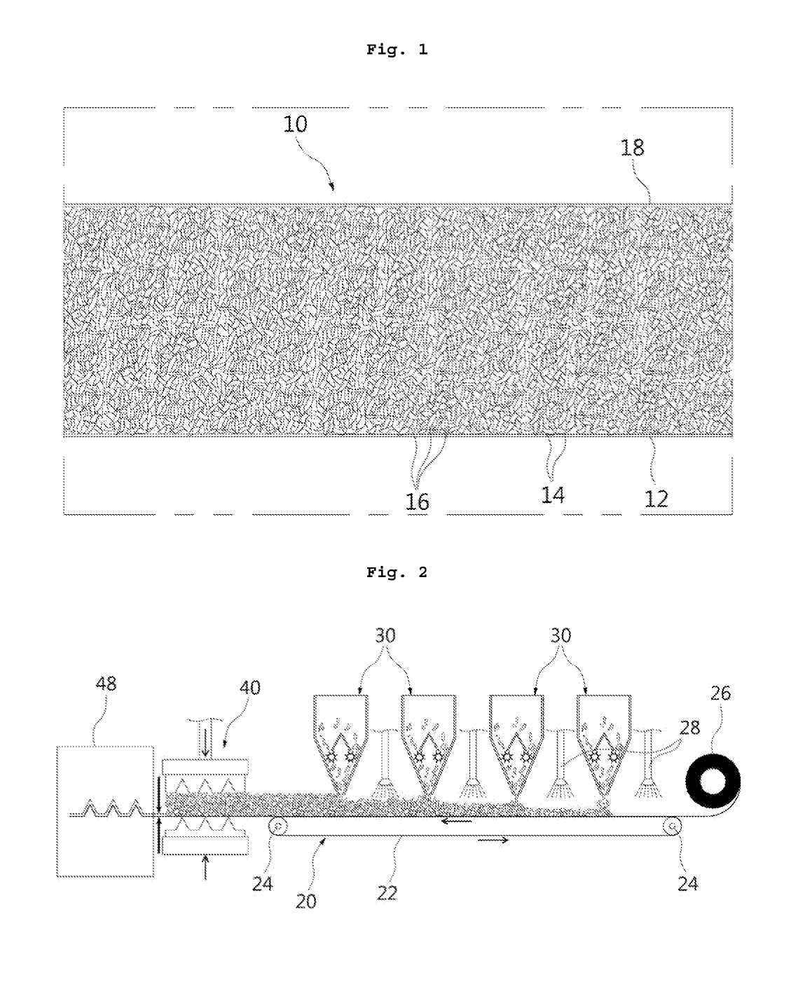

### MODE FOR INVENTION

Hereinafter, preferred embodiments of the present invention will be described in detail with reference to the accompanying drawings. Like reference numerals are used to identify like elements throughout different drawings. Further, in the following description, if it is decided that the detailed description of known functions or configurations related to the invention makes the subject matter of the invention unclear, the detailed description is omitted.

Further, when describing the components of the present invention, terms such as first, second, A, B, (a) or (b) may be used. Since these terms are provided merely for the purpose of distinguishing the components from each other, they do not limit the nature, sequence or order of the components. It will be understood that when an element is referred to as being “coupled” or “connected” to another element, it can be directly coupled or connected to the other element or intervening elements may be present therebetween.

As shown in the drawings, a porous paper sheet 10 according to an embodiment of the present invention is characterized in that paper pieces 14 are adhered to each other on a first base material 12 or are adhered to the first base material 12. The paper pieces 14 have various shapes, and predetermined pores are present therebetween. The present amount of the pores varies depending on the degree of pressure applied to the porous paper sheet 10.

The porous paper sheet 10 may be provided with a second base material 18 on a surface thereof opposite to where the first base material 12 is located. Of course, the second base material 18 is not necessarily required. The first base material 12 is not necessarily required as well. The first base material is a part on which the paper pieces 14 are placed in the process of manufacturing the porous paper sheet 10. However, when the initial first paper pieces 14, i.e., the paper pieces 14 forming the lowermost layer, are placed on a conveyor without being applied with the adhesive 16, and the paper pieces 14 placed thereon are applied with the adhesive 16, most of the paper pieces 14 placed at the lowermost layer and the paper pieces 14 placed thereon are adhered to each other except for part of the paper pieces 14, thereby forming the porous paper sheet 10 without provision of the first base material 12.

Meanwhile, a preferred embodiment of a device for manufacturing the porous paper sheet 10 is schematically shown in FIG. 2. According to this, a conveyor unit 20 is provided. The conveyor unit 20 includes an endless track conveyor belt 22 having a predetermined width and length, and the conveyor belt 22 is moved between at least two rollers 24. At least one of the rollers 24 serves to provide a driving force for driving the conveyor belt 22.

A first base material feeder 26 for feeding the first base material 12 to the conveyor belt 22 is located adjacent to the upstream end of the conveyor belt 22. The first base material feeder 26 serves to feed the first base material 12 wound in a roll shape at a constant speed.

An adhesive nozzle 28 is provided above the upstream side of the conveyor belt 22. The adhesive nozzle 28 is configured to supply an adhesive. A plurality of adhesive nozzles 28 are arranged at predetermined intervals in a moving direction of the conveyor belt 22. The adhesive nozzles 28 serve to apply the adhesive 16 to the first base material 12 or the paper pieces 14. One of the adhesive nozzles 28 located at the uppermost stream of the conveyor belt 22 applies the adhesive 16 to a surface of the first base material 12, and the remaining adhesive nozzles 28 apply the adhesive 16 to the paper pieces 14. The adhesive nozzles 28 apply the adhesive 16 over a width corresponding to the widthwise length of the conveyor belt 22. The width in which the adhesive nozzles 28 apply the adhesive 16 corresponds to the width of the porous paper sheet 10, which should not exceed the widthwise length of the conveyor belt 22.

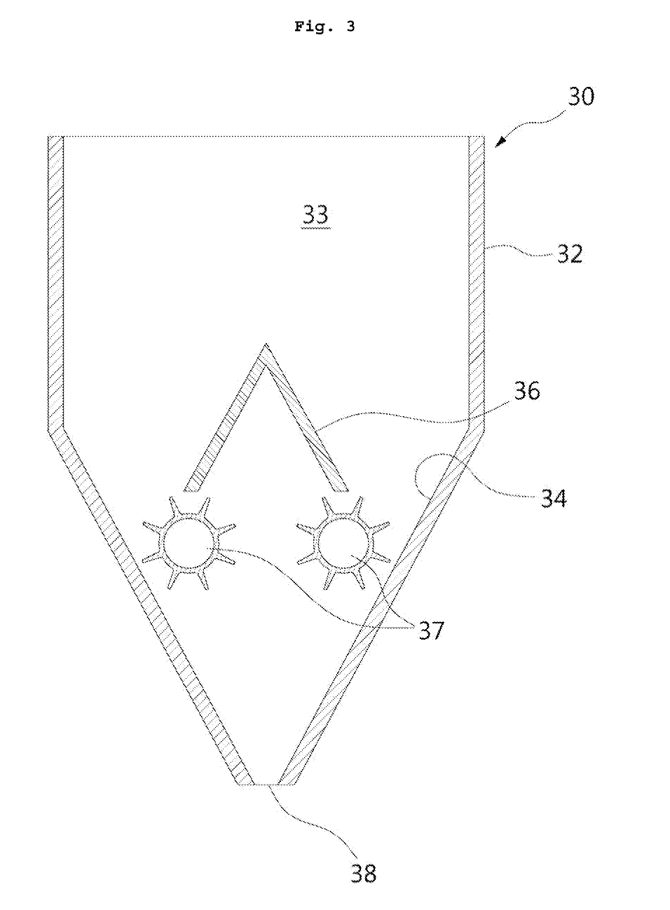

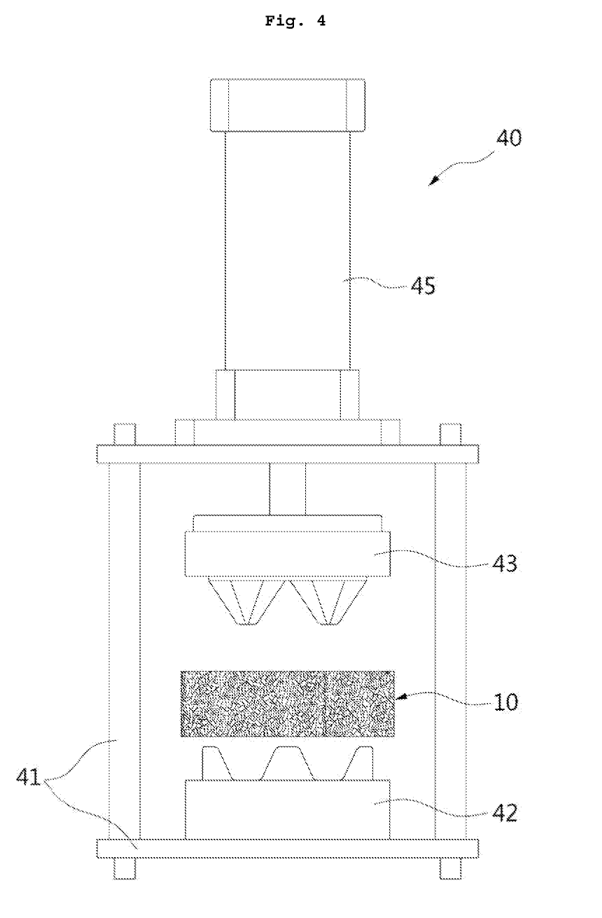

A paper piece feeder 30 is provided between each of the adhesive nozzles 28 and a neighboring adhesive nozzle 28. A detailed configuration of the paper piece feeder 30 is shown in FIG. 3. The paper piece feeder 30 serves to feed the paper pieces onto the first base material 12. A plurality of the paper piece feeders 30 is installed in rows in the moving direction of the conveyor belt 22.

A feeding hopper 32 forms an exterior shape of the paper piece feeder 30. The feeding hopper 32 is configured such that a cross-sectional area thereof gradually decreases downward from a predetermined height thereof toward the conveyor belt 22. An interior space 33 formed inside the feeding hopper 32 is open upward while communicating with outside through an outlet 38 of a lower portion of the feeding hopper 32 which will be described later. The feeding hopper 32 has a width corresponding to the width of the conveyor belt 22. Of course, the width of the feeding hopper 32 corresponds to the width of the porous paper sheet 10, but should not exceed the width of the conveyor belt 22.

The interior space 33 of the feeding hopper 32 is provided at a lower portion thereof with inclined surfaces 34 facing each other. The inclined surfaces 34 face each other and are configured such that widths thereof correspond to the width of the conveyor belt 22. The inclined surfaces 34 are inclined to gradually approach each other as going downward.

The interior space 33 is provided with a guide plate 36 extending in a width direction of the conveyor belt 22. Two guide plates 36 are provided to face the inclined surfaces 34, respectively. The paper pieces 14 in the interior space 33 are guided by the guide plates 36 to the facing inclined surfaces 34. Lower ends of the guide plates 36 are located at positions facing the inclined surfaces 34, respectively.

A guide roller 37 is provided at a position between each of the lower ends of the guide plates 36 and each of the inclined surfaces 34. The guide roller 37 is also configured such that a width thereof corresponds to the width of the conveyor belt 22. The guide roller 37 is provided on a surface thereof with a plurality of protrusions (not shown). The protrusions have a certain degree of flexibility and allow the paper pieces 14 to move along the inclined surfaces 34 while being brought into close contact with the inclined surfaces 34. The amount of paper pieces 14 transferred to the first base material 12 is determined according to rotational speed of the guide rollers 37.

The feeding hopper 32 is provided at the lower portion thereof with the outlet 38. The outlet 38 is configured such that a width thereof should not exceed the width of the conveyor belt 22. The paper pieces 14 are fed to the first base material 12 placed on the conveyor belt 22 through the outlet 38.

The plurality of paper piece feeders 30 and the plurality of adhesive nozzles 28 are sequentially arranged along the conveyor belt 22, so that the height of the paper pieces 14 laminated gradually increases toward the downstream side of the conveyor belt 22. The amount of paper pieces 14 laminated at one time must be enough such that the adhesive 16 is applied to most of the paper pieces 14. For reference, in a case where too many paper pieces 14 are fed, thus generating portions where the paper pieces 14 are not adhered to each other using the adhesive 16, and the porous paper sheet 10 manufactured may be easily separated at such portions.

The porous paper sheet 10 having passed through the conveyor belt 22 is formed in a predetermined thickness and shape using a press 40. For reference, the porous paper sheet 10 itself having passed through the conveyor belt 22 may be used as a packaging material without the use of the press 40.

Meanwhile, when the porous paper sheet 10 passes through the press 40, the porous paper sheet 10 is formed in a desired thickness and/or shape. For example, in a case where a flat porous paper sheet 10 is desired, both a lower mold 42 and an upper mold 43 which will be described below may have a flat shape.

The press 40 includes the lower mold 42 located at a relatively lower side of a press frame 41 and an upper mold 43 located over the lower mold 42. The lower and upper molds 42 and 43 have shapes corresponding to each other. In the shown embodiment, concave and convex portions are provided at corresponding positions of the lower and upper molds 42 and 43. In other words, the upper mold 43 has concave portions corresponding to convex portions of the lower mold 42, and the upper mold 43 has convex portions corresponding to concave portions of the lower mold 42. Such a configuration is suitable, for example, for a packaging material containing products such as eggs.

The upper mold 43 is installed on the press frame 41 to be movable upward and downward. A driving source 45 is installed on the press frame 41 for upward and downward movement of the upper mold 43. A hydraulic cylinder may be used as the driving source 45.

A drying unit 48 is provided at a position past the press 40. The drying unit 48 removes water contained in the adhesive 16 such that the porous paper sheet 10 is completely dried. To this end, the drying unit 48 provides heat. For reference, the press 40 may be installed in the drying unit 48 such that the porous paper sheet 10 is formed in a predetermined shape using the press 40 while at the same time being subjected to a drying process. In addition, a heating element may be built in the lower and upper molds 42 and 43, such that water removal is performed simultaneously with press work.

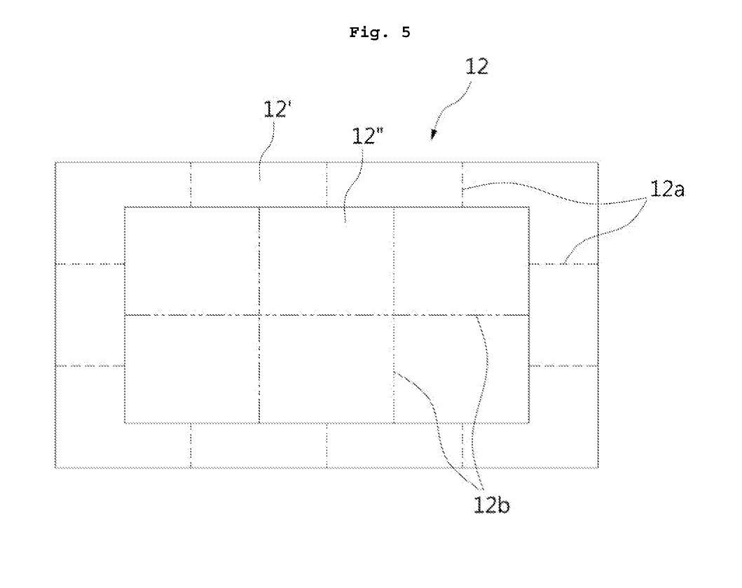

On the other hand, the first base material 12 or the second base material 18 may be torn in accordance with the shape in which a packaging material is formed when being compressed by the press 40. At this time, it may be required to prevent the paper pieces 14 from being exposed to outside. To this end, as shown in FIG. 5, for example, the first base material 12 may be composed of a first layer 12′ and a second layer 12″. In other words, several second layers 12″ are placed on the first layer 12′ such that even when the first layer 12′ is torn, a torn portion is covered by the second layers 12″ such that the paper pieces 14 are prevented from being exposed to outside. For reference, the second layer 12″ may be a single layer rather than a plurality of layers. In other words, although the first layer 12′ and the second layer 12″ have the same width and length, it is preferable that vertices of a lattice shape formed by second tear lines 12b are located at geometric centers of a lattice shape formed by first tear lines 12a while the first and second tear lines 12a and 12b do not overlap each other.

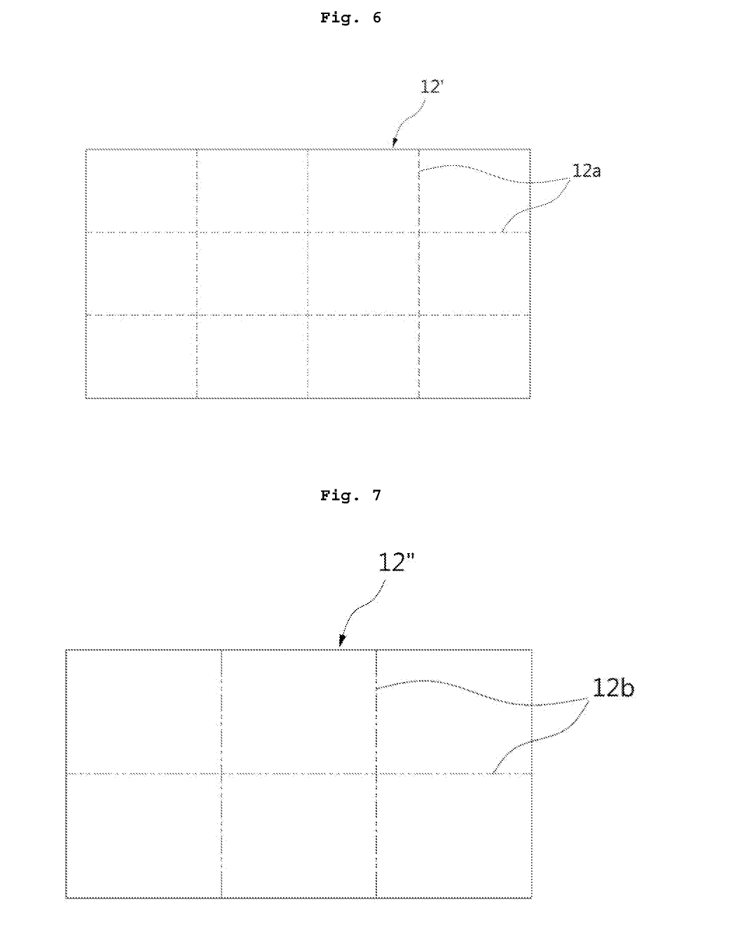

To this end, it is preferable to predetermine a portion to be torn in the first layer 12′. In other words, a predetermined portion of the first layer 12′ is allowed to be torn, and the second layer 12″ is allowed to be placed on the predetermined portion of the first layer 12′. To this end, the first layer 12′ has the first tear lines 12a forming a lattice shape so as to be torn therealong. Also, the second layer 12″ has the second tear lines 12b forming a lattice shape so as to be torn therealong. Herein, the first and second tear lines 12a and 12b are allowed to not overlap each other in lengthwise directions thereof, but intersect at predetermined positions to form a quadrangle. The first layer 12′ is shown in FIG. 6, and the second layer 12″ is shown in FIG. 7. A state in which the second layer 12″ is placed on the first layer 12′ is shown in FIG. 5.

Furthermore, in a case where both the first base material 12 and the second base material 18 are placed on the porous paper sheet 10, a second base material feeder (not shown) is arranged at a position past the last adhesive nozzle 28 to feed the second base material 18.

Hereinafter, a method of manufacturing the porous paper sheet according to the present invention having the above-described configuration using the above-described device will be described.

A process of manufacturing the porous paper sheet 10 will be described with reference to FIG. 2. The first base material 12 unrolled from the first base material feeder 26 is placed on the conveyor belt 22 and is then moved by driving of the conveyor belt 22.

The adhesive 16 is sprayed from a first adhesive nozzle 28 and applied to the first base material 12 moving along the conveyor belt 22. Next, while the first base material 12 passes through the first paper piece feeder 30, the paper pieces discharged through the outlet 38 are attached to the first base material 12 using the adhesive 16.

When the first base material 12 has passed through the first paper piece feeder 30, the adhesive 16 sprayed from a second adhesive nozzle 28 is applied and attached to the paper pieces 14. When the first base material 12 having been applied with the adhesive 16 passes through a second paper piece feeder 30, the paper pieces 14 are again laminated thereon, and the paper pieces 14 are then attached to the lower paper pieces 14 using the adhesive 16.

When the paper pieces 14 are laminated a plurality of times using the adhesive 16 in such a manner, a porous paper sheet 10 having a desired height is manufactured. If the second base material 18 is required, the adhesive nozzle 28 is arranged at a position past the last paper piece feeder 30 and applies the adhesive 16 to the uppermost paper pieces 14, and then the second base material 18 is placed thereon to be adhered thereto.

On the other hand, in a case where the porous paper sheet 10 is desired to be formed in a predetermined shape, it is allowed to pass through the press 40. The porous paper sheet 10 is compressed between the lower mold 42 and the upper mold 43 of the press 40, thereby being formed in a desired shape.

Then, the drying unit 48 applies heat to remove water contained in the porous paper sheet 10, such as in the adhesive 16, etc. When such a process is completed, the porous paper sheet is cut into a predetermined length and used as a packaging material.

In a case where the first base material 12 or the second base material 18 is likely to be torn due to the characteristics of the shape manufactured in the press 40, they may be formed by overlapping the first layer 12′ and the second layer 12″. Due to this, it is possible to prevent the paper pieces 14 from being exposed to the surface of the porous paper sheet 10. In the shown embodiment, the first base material 12 fed from the first base material feeder 28 may be formed of the first layer 12′ and the second layer 12″ in advance.

Although the preferred embodiment of the present invention have been disclosed for illustrative purposes, those skilled in the art will appreciate that various modifications, additions and substitutions are possible, without departing from the scope and spirit of the invention as disclosed in the accompanying claims. Therefore, embodiment of the present invention is presented to make complete disclosure of the present invention and help those skilled in the art best understand the invention. The scope of the invention should be determined on the basis of the descriptions in the appended claims rather than any specific embodiment, and all equivalents thereof should belong to the scope of the invention.

1. A porous paper sheet, comprising:
a first base material; and
paper pieces laminated on the first base material, and adhered to each other or adhered to the first base material using an adhesive such that the paper pieces have predetermined pores therebetween, the paper pieces being shredded in a predetermined size.

2. The porous paper sheet of claim 1, further comprising:
a second base material provided at a position opposite to the first base material and adhered to the laminated paper pieces using the adhesive so as to cover the paper pieces.

3. The porous paper sheet of claim 1, wherein a pre-compression configuration is provided such that the first base material or the second base material includes a first layer having first tear lines formed in a lattice shape and a second layer having second tear lines formed in a lattice shape at a position apart from the first fold lines of the first layer.

4. The porous paper sheet of claim 3, wherein the pre-compression configuration is provided such that vertices of the lattice shape formed by the second tear lines are located at geometric centers of the lattice shape formed by the first tear lines.

5. A device for manufacturing a porous paper sheet, the device comprising:
a first base material feeder feeding a first base material;
a conveyor unit including a conveyor belt on which the first base material is placed and rollers driving the conveyor belt;
an adhesive nozzle positioned above the conveyor belt and applying an adhesive to the first base material; and
a paper piece feeder positioned above the conveyor belt and feeding paper pieces to the first base material.

6. The device of claim 5, wherein a plurality of adhesive nozzles and a plurality of paper piece feeders are arranged in an alternate manner.

7. The device of claim 6, further comprising:
a drying unit drying the porous paper sheet having passed through the conveyor belt.

8. The device of claim 5, wherein the paper piece feeder includes:
a feeding hopper provided with an interior space in which the paper pieces shredded are placed, and at a lower portion thereof with an outlet through which the paper pieces are discharged onto the conveyor belt;
guide plates guiding the paper pieces to inclined surfaces formed at a lower portion of the interior space of the feeding hopper; and
guide rollers respectively positioned between the inclined surfaces and the guide plates and guiding the paper pieces to the outlet at a constant speed.

9. The device of claim 5, further comprising:
a press provided with a lower mold and an upper mold to form the porous paper sheet having passed through the conveyor belt in a predetermined shape.

10. A method of manufacturing a porous paper sheet configured such that paper pieces shredded to a predetermined size are adhered to each other on a first base material or adhered to the first base material using an adhesive such that the paper pieces have predetermined pores therebetween, the method comprising:
feeding the first base material;
applying the adhesive and the paper pieces alternately on the first base material;
compressing the paper pieces having the pores therebetween and laminated on the first base material using the adhesive, and forming the paper pieces in a predetermined shape; and
drying the first base material and the paper pieces to remove water contained therein.

11. The method of claim 10, wherein the applying the adhesive and the paper pieces is carried out a plurality of times.
